(19) United States
(12) Patent Application Publication
(10) Pub. No.: US 2026/0295543 A1
(43) Pub. Date: Oct. 1, 2026

(54) STATIC MIXING ELEMENTS WITH A SEPARATOR AND DEFLECTING SURFACES AND STATIC MIXERS

(71) Applicant: medmix Switzerland AG, Haag (Rheintal) (CH)

(72) Inventor: Felix STREIFF, Humlikon (CH)

(21) Appl. No.: 19/477,298

(22) PCT Filed: Apr. 15, 2024
(86) PCT No.: PCT/CH2024/050019

§ 371 Date: Oct. 21, 2025

(30) Foreign Application Priority Data
Apr. 24, 2023 (CH) 000427/2023

(51) Int. Cl. B01F 25/431; B01F 23/40; B01F 23/43; B01F 23/45; B01F 23/47; B01F 27/1125; B01F 33/81; B01F 101/00

(52) U.S. Cl. CPC B01F 25/43171; B01F 23/43; B01F 23/45; B01F 23/47; B01F 23/482; B01F 27/11253; B01F 33/811; B01F 2101/2805

(57) ABSTRACT

A static mixing element in a flow channel of a tube, includes a separating web with a height and extending in a plane through an axis of the tube in parallel to an axial flow direction and extending over the diameter thereof, two blade-like deflection surfaces adjoining the separating web in planes transverse to the tube axis, the two blade-like deflection surfaces completely covering a sector of a cross-section and delimiting two axial sections in an axial projection, and two windows for axial passage of a flow from a first axial section on an inlet side to respectively opposite sides of the separating web into a second axial section on an outlet side, the deflection surfaces having raised edges as lateral boundaries to the windows on the inlet side, the raised edges meeting in the axis of the tube and protruding against a flow direction over the deflection surface.

### CROSS REFERENCE TO RELATED APPLICATION

This application is a U.S. national stage application of International Application No. PCT/CH2024/050019, filed on Apr. 15, 2024 which claims priority to Switzerland Patent Application No. 000427/2023 which was filed on Apr. 24, 2023, the contents of each of which are hereby incorporated by reference.

### TECHNICAL FIELD

The disclosure relates to static mixing elements and static mixers in a flow channel, preferably in a circular tube with at least one separating web per mixing element, deflection surfaces, and windows for axial flow. Such static mixers are preferably used in the laminar flow range with highly viscous media. Typical applications are disposable mixers for curing resins, adhesives, or static mixers for plastic melts in plastics processing with injection molding machines or by means of extrusion.

### BACKGROUND

To date, many static mixers are known and in use in which the flow is divided into partial flows by dividers or channels and deflected by deflection surfaces. A static mixer is formed by several such mixing elements arranged linearly one behind the other in a tube or flow channel in the direction of flow. In many known static mixers, the flow is divided into two partial flows, twisted or rearranged, compressed, and expanded again. The mixing process is similar to the process in a calender (calender model). According to an idealized concept, laminar flow creates layers in each mixing element, and the number of layers doubles from mixing element to mixing element. In practice, the actual number of layers or their thickness often deviates from this ideal by orders of magnitude after a larger number of mixing elements. The oldest static mixers using this mixing principle were the Multiflux (U.S. Pat. No. 3,051,453) and the baffle mixer (U.S. Pat. No. 3,286,992). The baffle mixer is still widely used today in so-called disposable mixers for reactive resins and adhesives, because it allows entire mixer rods consisting of many such mixing elements to be manufactured from plastic in large quantities at low cost from a single piece using simple, two-part injection molding tools. The mixing elements of the baffle mixer occupy only a small proportion of the mixer volume and therefore exhibit low pressure loss. The length of a mixing element is typically 1.5 times the tube diameter D, and the mixer length required for homogenization is typically 30 D (D=tube diameter). In contrast to this, the mixing elements of the Multiflux mixer occupy up to 30% of the mixer volume, resulting in a significantly greater pressure loss. However, the mixer length required for homogenization is much shorter than for the reverse mixer, typically 10 D. Both mixers divide the flow into two channels or partial flows and bring them back together to divide them again. The baffle mixer has a circular cross-section of the flow channel, while the Multiflux mixer in its original form was preferably used with a square cross-section of the flow channel because this achieved a better mixing result. However, there are also known embodiments of this mixer with a circular cross-section of the flow channel, which can also be manufactured from plastic with a two-part tool.

Today, mixers according to EP 0749776A1 or EP 0815929A1, e.g., for use as disposable mixers, are available as static mixers with the same mixing principle as the Multiflux mixer, but with a simpler and improved design. Here, too, entire mixer rods can be manufactured with simple, two-piece tools made of injection-molded plastic. The length of a mixing element according to these disclosures is only approx. 0.5 D, and the mixing elements occupy a volume of less than 10% of the volume assigned to the mixer. This results in low pressure loss and a very short homogenization length of approx. 8 D. Today, a large number of similar, derived or related mixer structures are known, for example according to U.S. Pat. No. 3,239,197, EP 1 149 626A1, WQ2017/027275A2, EP 1 125 626A1, EP or EP 3 338 882A1.

The relative standard deviation s/x from a concentration measurement across the cross-section is frequently used as a measure of the mixing quality for a mixture in a static mixer. In this connection s is the measured standard deviation and x is the measured mean value of the concentration in a cross-section. This relative standard deviation is also referred to as the coefficient of variation COV. The conductivity method [Chem. -Ing.-Tech.52(1980) 4, pages 285-291] is frequently used for concentration measurement. Two viscous partial flows with different electrical conductivities are pressed through the static mixer and mixed. To measure conductivity or concentration, a measuring probe is pulled across the outlet cross-section. A newer, experimental measurement method is the LIF (Laser Induced Fluorescence) method [The Canadian Journal of Chemical Engineering, Volume 76, June 1998]. To measure concentration, a fluorescent tracer induced by a laser beam is used. With this measurement method, the flow is not influenced by a measuring probe. Finally, numerical flow simulation (CFD) does not require any experiments at all. The COV depends on the measurement method and the sample size. Having regard to numerical flow simulation, the result can also be strongly influenced by the model used and numerical influences. A mixture with a COV=1% is considered homogeneous. The corresponding mixer length is referred to as the homogenization length.

The formation of layers in laminar flow can also be demonstrated very easily and accurately by pressing two highly viscous resin components mixed with hardener and curing in a short time, with different colors added with pigment, through a mixer. The cured mixer rod is then cut open after each mixing element. In this way the mixing process or mixing state is frozen in a cross-section forever without being influenced by diffusion or other factors, and can be easily analyzed. The only disadvantage is that the mixer being examined is lost or also “frozen.” Today, prototypes of mixers can be produced easily and inexpensively from plastic using 3D printing. This has made this old examination method very interesting again. A simple evaluation is to count the layers formed or, even simpler and more reliable, to measure the maximum layer thickness I in a cross-section. If the measurements of the maximum layer thickness I are compared, for example, with the conductivity method, it can be seen that the homogenization length (COV=1%) is reached at a layer thickness of approx. 25 μm. Since this layer thickness is hardly measurable, it is determined by exponential extrapolation. The mixing effect of the known static mixers in the laminar range is very good in some cases and, although it does not follow the ideal, it does follow an exponential layer formation law. Many static mixers with circular tube cross-sections share a problem that has not yet been solved. The layer thicknesses across the cross-section and under the layers can vary greatly, or the layers do not extend across the entire cross-section. In mixers similar to the Multiflux mixer or the EP 0749776A1 with a round tube cross-section, there is a significant deviation in the thickness of the layers in the edge areas compared to the layers in the inner area. This effect is less pronounced with a square cross-section of the flow channel. For this reason, disposable mixers with these or similar mixer geometries, such as those described in EP 0749776, are usually offered with square housings, although a circular tube would be preferred as a housing. In many applications, a square housing is not an option and other static mixers are preferred. One example of this is static-dynamic mixing systems in which a mixer vane is additionally set into rotation by a drive.

FIG . 1 shows the distribution of the layers and layer thicknesses determined from the cross-sectional images in tests with a static mixer according to EP 0749776 with a square cross-section. The images were traced from the photographic evaluation of the cross-sectional images. In this connection image a) shows the state at the inlet (mixture 1:1, black/white), image b) shows the state at the outlet of the first element, and image c) shows the state at the outlet of the second element. It can be clearly seen that the number of layers formed corresponds very well to the expectations according to the calender model, but also that the layer thicknesses are not uniform even with a square flow cross-section and that the edge layers are significantly larger than expected. This deviation remains consistent across all other mixing elements, although the thickness of the layers decreases steadily and exponentially as the mixer length increases. The mixing quality, in the form of a decreasing maximum layer thickness I, is significantly lower than expected according to an ideal mixing law. FIG. 7, trend line 2 shows the course of the measured maximum relative layer thickness 1/1₀ for this mixer, represented as a function of the relative mixer length L/D. Trend line 3 shows the course of the relative layer thickness over the relative mixer length according to the same measurements for a baffle mixer with a circular flow cross-section. After just a few tube diameters, the layer thickness is already an order of magnitude higher than in line 2. European patent application EP 3907461 A1 describes a possible solution for further improving layer formation in the mixer in accordance with EP 0749776 this is achieved by enlarging the deflection surfaces beyond the separating web on the inlet side in a suitable shape and direction, thereby reducing the window areas.

### SUMMARY

This allows a somewhat more uniform distribution of layer thicknesses to be achieved. This solution was developed mainly for applications as mixer heat exchangers, also to improve heat transfer to the tubes at the same time. However, it has been determined that when this solution was used for disposable mixers or for other static mixing tasks without heat transfer, the pressure loss was increased more than desired. All of the above-mentioned static mixers, with the exception of the baffle mixers, also exhibit unfavorable residence time behavior because zones with greatly differing axial flow velocities or even stagnant zones occur. Such zones cure prematurely when processing resins with a short pot life, resulting in the mixers having to be replaced more often. To date, no satisfactory solution to the problem of uneven distribution of layer thickness or thicker layers at the edge has been found, especially for disposable mixers with circular flow channels.

The object of the present disclosure is to find a static mixer or disposable mixer with low pressure loss that achieves a significantly more uniform distribution of layer thicknesses across the cross-section and thus a shorter homogenization length than the known static (disposable) mixers, in particular with a circular tube as the mixer housing with low pressure loss, and which can be easily manufactured with a two-part open/close (O/C) tool and as a whole mixer rod as a monolithic part. In addition, an improvement in the residence time distribution or a reduction in stagnant zones is to be achieved.

This object is satisfied by the features disclosed herein. Other particularly advantageous embodiments or applications of the disclosure are further described.

The term “blade-like deflection surfaces” encompasses both completely planar and curved deflection surfaces, for example concavely and/or convexly curved deflection surfaces.

### BRIEF DESCRIPTION OF THE DRAWINGS

The disclosure is explained in the following with reference to the drawings.

FIGS. 1A-1C and representations of the layer thicknesses as measured with cured resins in a mixer according to EP 0749776 with a square cross-section. The image was traced from the photographic evaluation. FIG. 1A: Mixer inlet, FIG. 1B: outlet from mixing element 1, FIG. 1: outlet from mixing element 2.

FIG. 2 is a perspective representation of a tube 1 with a static mixing element according to the disclosure with a length H with 2 blade-like deflection surfaces 4,5 with edges 6,7 on the inlet side (section I) and a separating web 2 with a width D and a height h in an axial plane through the tube axis 3 on the outlet side (section II). Cross-sectional planes E1 (mixing element inlet), E2 (intermediate plane at the transition from deflection surfaces to separating web) and E3 (mixing element outlet). The arrows indicate the cross-flow directions in the individual sections. The preferred axial flow direction is indicated by the large arrow in the tube axis.

FIG. 3 is an axial section (plane EB, FIG. 4) through the tube axis and perpendicular to the separating web 2 of a mixing element according to the disclosure with inclined deflection surfaces and flow area F enlarged without inclination compared to the value Dxh. The sectional surfaces are not hatched for better understanding. The direction arrows indicate the cross-flow directions in sections I and II.

FIG. 4 is a view from the inlet side of a mixing element type A according to the disclosure with a separating web 2 in an axial plane EA and deflection surfaces 4 and 5 and windows 8 and 9 in a tube 1. In this example, the edges 6, 7 on the inlet side form a common, straight web through the tube axis, which is at an angle β to the separating web 2.

FIG. 5 is a view from the inlet side of a mixing element type B according to the disclosure, which is constructed as a mirror image of element type A with deflection surfaces 4′ and 5′ and windows 8′ and 9′ offset relative to the separating web 2 and 2′, respectively. The separating webs 2, 2′ of successive mixing elements of type A and type B are preferably in parallel to each other in a common axial plane EA in the center of the tube. The entry edges of the edges are preferably chamfered.

FIG. 6 is an illustration of the distribution and thickness of the layers formed after tests with cured resins at the outlet of the second mixing element for a mixer according to the disclosure in a circular tube. The image was traced after photographic evaluation.

FIG. 7 is a progression of the measured maximum layer thickness I in comparison to the initial thickness Iₒ as a function of the relative mixer length L/D for the mixer according to the disclosure (1) with a circular cross-section, a mixer according to EP 0749776 with a square cross-section (2) and a baffle mixer (3) as exponential trend lines.

FIG. 8 is a longitudinal section transverse to the separating web (plane EB) through an entire mixer rod consisting of mixing elements type A and type B with lateral connecting elements 10, 11 in a flow channel 1.

FIG. 9 is a view from the inlet side of the mixer rod according to FIG. 8 with lateral connecting elements 10, 11 that adapt to the tube cross-section and which can be manufactured as a disposable mixer with a simple, two-part tool and made of injection-molded plastic. The opening direction of the tool divided in the EB plane is indicated by the arrows C/O.

FIG. 10 is a longitudinal section (plane EB) through a mixing element according to the disclosure with ring 12 for reinforcement, which can be manufactured as a particularly strong, monolithic mixing element, e.g., as a precision casting or in 3D printing, and is inserted into a tube with diameter D. Individual mixing elements with rings can also be manufactured from plastic or wax using a simple, two-part tool.

FIG. 11 is a view from the inlet side of a mixing element according to the disclosure with ring 12 according to FIG. 10 FIG. 12 is a longitudinal section through a mixing element according to the disclosure with convexly curved deflection surfaces FIG. 13 is a longitudinal section through a mixing element according to the disclosure with concavely curved deflection surfaces FIG. 14 is a view from the inlet side of a mixing element according to the disclosure in which the edges of the deflection surfaces form a curved line FIG. 15 is a view from the inlet side of a mixing element according to the disclosure with a square flow cross-section.

### DETAILED DESCRIPTION

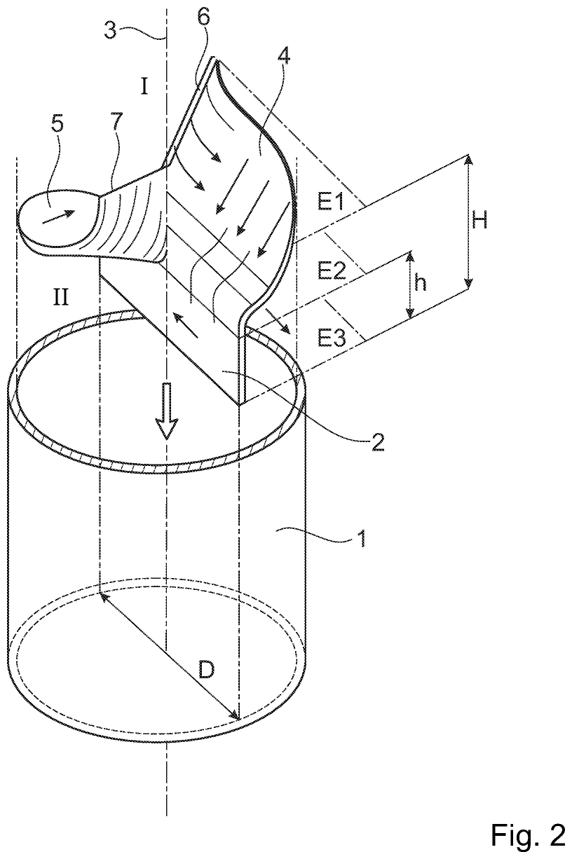

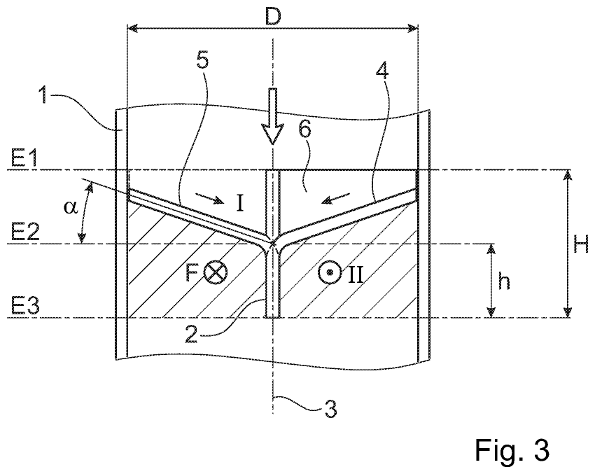

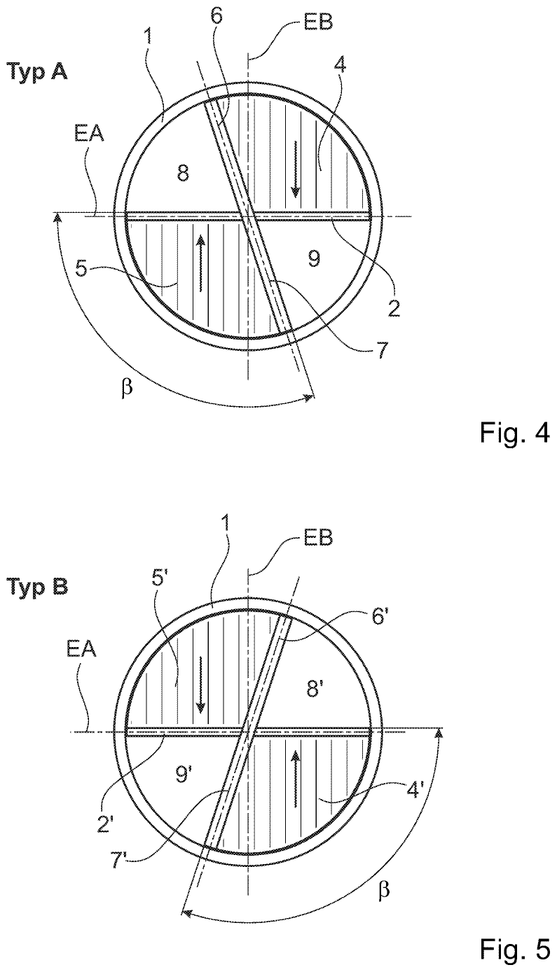

The static mixer according to the disclosure, preferably in a tube 1, is formed of mixing elements, each with a separating web 2 of height h in a plane through the tube axis 3, in parallel to the axial flow direction and extending over the entire cross-section, and two blade-like deflection surfaces 4, 5 with edges 6, 7 are attached to the separating web 2, which in the axial projection completely cover a sector of the cross-sectional area, and two windows 8, 9 for the axial passage of the flow. It is particularly advantageous if the covered sector is 56%-67% of the radial cross-sectional area. If the edges 6, 7 on the inlet side form a straight web over the cross-section, this corresponds to an angle β=100-120°. With greater coverage, the pressure loss increases and a reversal occurs such that the layers near the separating web become larger than at the edge. The deflection surfaces separate two axial sections, I and II. The section I is the region upstream of the deflection surfaces to the inlet plane E1. The inlet plane E1 is perpendicular to the tube axis 3 and contacts the upper edge of a mixing element. The section II is the region downstream of the deflection surfaces to the outlet plane E3. The outlet plane E3 lies in parallel to the inlet plane E1 and also perpendicular to the tube axis 3 and contacts the lower edge of a mixing element and/or of the separating web 2. In section I, the flow is shifted transversely to the axial flow direction in opposite directions into the windows 8,9, divided and compressed, and the partial flows reach opposite sides of the separating web 2 in section II. Here, the flow is expanded back to the full cross-section. In the outlet plane E3, the partial flows are recombined in order to be divided again in the next mixing element. The edges 6, 7 hold the flow on the deflection surfaces 4 and 5, respectively, and prevent it from entering the adjacent window on the same side of the separating web 2. The lateral edges of the deflection surfaces meet in the tube axis and form a straight or curved surface that also extends across the entire cross-section and protrudes against the direction of flow beyond the deflection surface. The edges preferably extend in parallel to the direction of flow, at least at the inlet. However, they CAN also have an inclination to this. The height of the edge above the deflection surface CAN vary across the diameter. Preferably, however, the edges are raised up to the inlet plane E1 of a mixing element and also form a straight or curved web surface on the inlet side, or the edges 6 and 7 together form a straight web that extends across the entire cross-section. The deflection surfaces 4,5 lie in planes transverse to the tube axis, but are raised from the cross-sectional plane E2 and against the direction of flow. The cross-sectional plane E2 runs perpendicular to the tube axis, in parallel to the planes E1 and E3 and through the upper edge of the separating web 2. By raising the deflection surfaces, the area F (FIG. 3) below the deflection surfaces in section II and perpendicular to the separating web 2 in section II is increased by 25-50%. If the deflection surfaces are planar and straight, this would correspond to an angle of inclination of α=15-30° to the cross-sectional plane E2. In this connection the inclination on both sides of the separating web 2 should be opposite and against the respective window. The area F, downstream of the deflection surfaces 4, 5 and extending to the outlet plane E3, forms the passage area in a mixing element for the cross-flow along the separating web 2. It is perpendicular to the separating web 2 in the plane EB through the tube axis. The arrows in FIGS. 2 and 3 indicate the transverse-flow directions in the individual sections. The preferred axial flow direction is from section I to section II (large arrow in FIG. 2) respectively from plane E1 to plane E2.

In mixing tests with curing resins using such mixing elements, in which only the deflection surfaces were inclined at an angle α but not enlarged (β=90°), there was a surprising increase in layer thickness at the edge compared to deflection surfaces in the cross-sectional plane. This applies to both square and circular cross-sections. If, on the other hand, in the case of deflection surfaces in the cross-sectional plane (α=0°), only the coverage by the deflection surfaces is increased or the angle β>90° is selected, the layer thicknesses are somewhat more uniform. However, this measure is much more effective if the deflection surfaces are raised from the cross-sectional plane at the same time. The distribution of layer thicknesses is most uniform when the two measures are cleverly combined.

The enlarged deflection surfaces reduce the narrowest cross-section in the windows in the axial projection. This would increase the pressure loss in the mixing elements if the deflection surfaces were located in the cross-sectional area E2, and zones with very different flow velocities or even stagnant zones would be formed. The additional inclination or elevation of the deflection surfaces to the cross-sectional plane increases the flow cross-section for propagation in the direction of the separating web in section II. This reduces the pressure loss and at the same time improves the velocity distribution and the residence time distribution. Both the deflection surfaces and their edges can have a curved, arched, or wedge-like shape instead of a flat one (FIGS. 12, 13, and 14). To further improve the residence time distribution, the transitions from webs or edges to the deflection surfaces can have large curvatures. If the mixing elements are connected to connecting elements or to an outer ring, the deflection surfaces or the edges and webs at the transitions to these elements can also be wedge-shaped or reinforced by large curves to reduce dead zones and increase strength.

There is no upper limit for the height h of the separating web 2 or for the length H of a mixing element. The pressure loss decreases with increasing length h of the separating webs or H of the mixing elements. If, on the other hand, the length is shortened, the empty volume fraction decreases and the pressure loss increases, but the mixing quality (layer thickness) relative to 1 mixing element remains approximately the same. Thus, the mixing quality per length increases. It has been shown that an ideal result in terms of mixing quality and pressure loss is achieved in most cases when h=0.2-0.35 D and H=0.4-0.7 D are selected. The mixing elements normally have a void volume fraction of >90%.

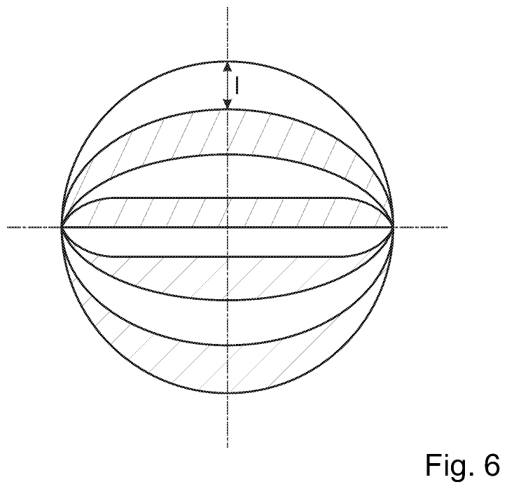

A static mixer is formed by a sequence of mixing elements of type A (FIG. 4) and type B (FIG. 5) arranged one behind the other in the direction of flow until the desired mixing condition is achieved. In this connection the type A and type B elements are identical except for the mirror-image arrangement of the deflection surfaces, i.e., the windows 8 and 9 of type A and the windows 8′ and 9′ of type B are located on opposite sides of the separating web 2 respectively 2′. The deflection surfaces 4 and 4′ or 5 and 5′ respectively are inclined in the opposite direction to the separating web 2 or 2′. The separating webs 2 or 2′ of successive mixing elements are preferably located in a common axial plane EA through the center of the tube. As a result, the windows and deflection surfaces of successive mixing elements cover each other. Mixing elements arranged one behind the other are preferably installed without gaps for a compact design. However, they can also be installed with gaps.

The favorable effect of this disclosure was clearly demonstrated with the help of the described experiments with curing resins and the cross-sectional images.

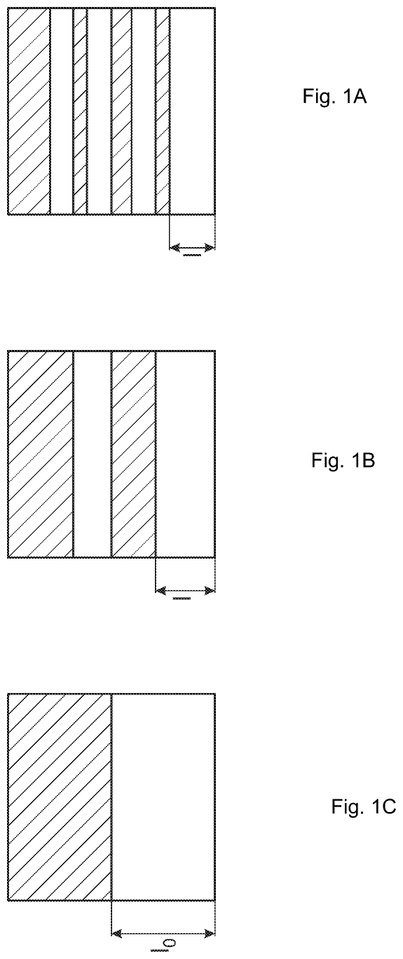

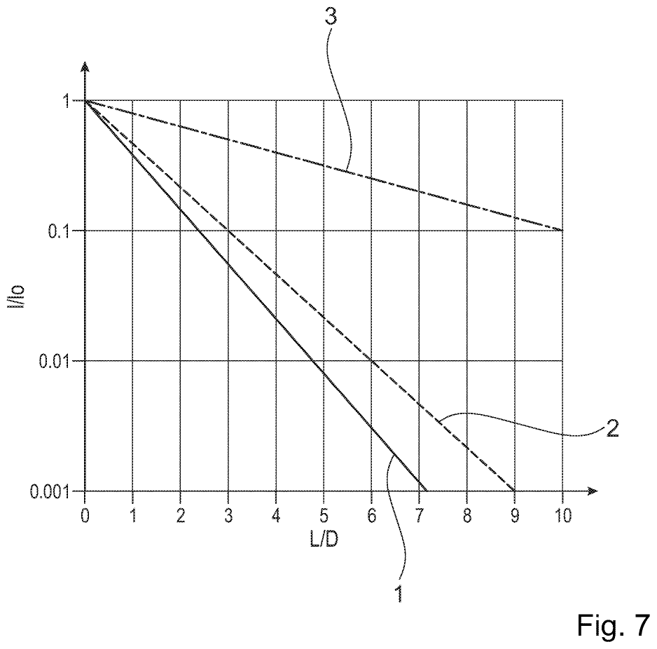

FIG. 6 shows the distribution of the layers formed and their thickness at the outlet of the second mixing element in an embodiment of the mixing elements according to the disclosure for a circular tube. The image was also traced from the photographic evaluation of the cross-sectional images. The distribution of layer thicknesses across the cross-section is already significantly more uniform here than in FIG. 1C. The trend continues in accordance with the exponential decrease in layer thicknesses in the further mixing elements. FIG. 7 shows the progression of the measured maximum layer thickness I in comparison to the initial thickness 1₀ as a function of the relative mixer length L/D for the mixer according to the disclosure with a circular cross-section (1) and the mixer according to EP 0749776 with a square cross-section (2) as well as for a baffle mixer (3), also with a circular cross-section, as exponential trend lines. In this connection a major advance is that, in the mixer according to the disclosure, even in a circular tube, the relative layer thickness 1/1ₒ of the known mixer according to EP 0749776 with a square cross-section is halved after only 6 tube diameters. The difference becomes greater and greater as a result of the exponential decrease in layer thicknesses the longer the mixing distance is. The result is a significantly shorter homogenization length of only approx. 6 D. Thanks to the possibility of using normal tubes as housings, the mixers are significantly cheaper to manufacture and easier to handle.

Since the deflection surfaces cover at least 56% of the cross-sectional area in the projection, the formation of mixing-resistant strands that are only slightly deflected by the separating web 2 is avoided at the same time, because these are better intercepted by the deflection surfaces.

### Description of Manufacturing and Implementation Examples

Individual mixing elements as shown in FIG. 2 can be easily manufactured, for example, from two sheet metal cutouts (laser, water jet) or punched developments. The sheet metal is bent to the desired shape and the two halves are joined using a conventional method such as welding, gluing, soldering, riveting, screwing, etc. Of course, the mixing elements can also be assembled from more than two individual parts. The mixing elements are then inserted into a tube either individually or connected to form complete mixer rods using connecting elements. The connecting elements also ensure that the mixing elements are correctly aligned behind each other. The connecting elements also serve to absorb the axial forces that occur due to the pressure drop. Supports or retaining rings are used for the axial positioning of the mixer in the tube, or the mixing elements are at least partially connected to the tube, e.g., by welding. Individual mixing elements or entire mixing rods made of plastic or metal can also be manufactured using a 3D printing process.

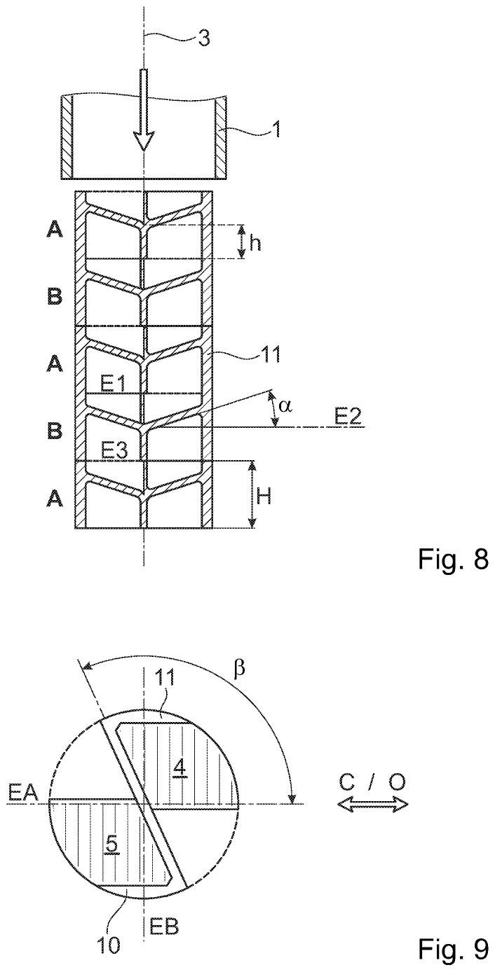

Entire mixing rods as disposable mixers consisting of a large number of individual elements of type A and type B are manufactured in one piece using a plastic injection molding process or, in the case of metal, also using a precision casting process (FIGS. 8 and 9). The mixer parts are connected to each other by external axial elements 10, 11 in such a way that the entire part can be manufactured with a simple, two-part open/close tool (O/C) and the outer shape is adapted to the circular tube cross-section (FIGS. 8 and 9). This design is particularly advantageous as a disposable mixer compared to the previously known disposable mixers with their impractical square housing cross-section.

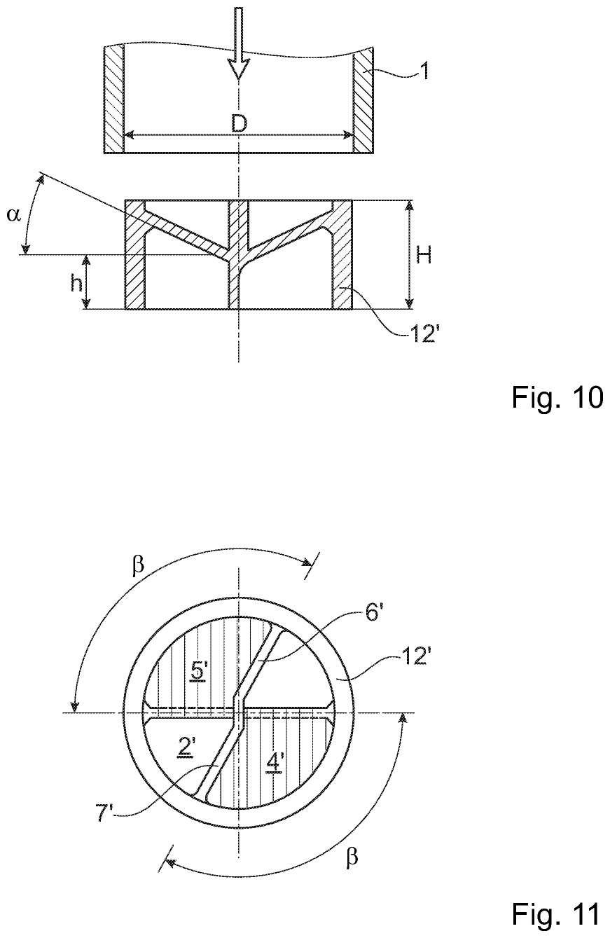

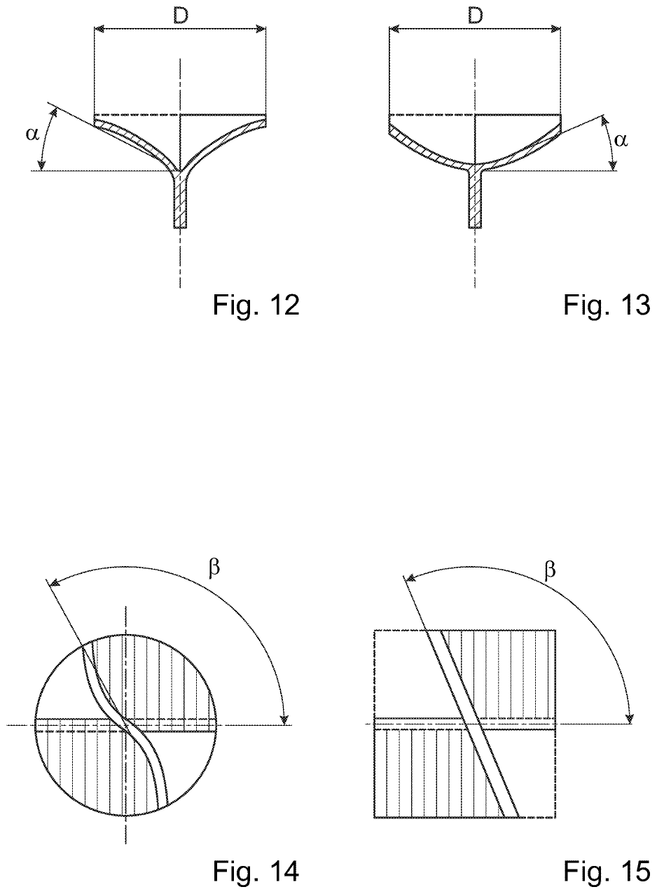

If particularly high strength of the mixing elements is required, e.g., when used as a mixer for plastic melts in extrusion or in the injection molding of plastic parts, the individual mixing elements are firmly connected with an outer ring 12 (FIGS. 10 and 11) to absorb the compressive forces, or manufactured as precision castings (lost wax casting process) or in 3D printing from a single piece. Mirror-image elements of type A and type B are then installed in the housing one behind the other in the direction of flow and form the static mixer. Special cams and grooves or pins and holes are used to ensure that the mixing elements are positioned correctly one behind the other.

1. A static mixing element in a flow channel of a tube, comprising:
a separating web with a height and extending in a plane through an axis of the tube in parallel to an axial flow direction and extending over an entire diameter thereof;
two blade-like deflection surfaces adjoining the separating web in planes transverse to the tube axis, the two blade-like deflection surfaces completely covering a sector of a cross-section and delimiting two axial sections in an axial projection; and
two windows for axial passage of a flow from a first axial section on an inlet side to respectively opposite sides of the separating web into a second axial section on an outlet side,
the deflection surfaces having raised edges as lateral boundaries to the windows on the inlet side, the raised edges meeting in the axis of the tube and protruding against a flow direction over the deflection surface,
the deflection surfaces or axial projections thereof completely cover an area of at least 56% of the tube cross-section, and the deflection surfaces being mutually inclined towards a center web and towards a cross-section plane or being raised from the cross-section plane,
such that a area downstream of the deflection surfaces and up to the an outlet plane in an axial plane, perpendicular to the separating web and through the tube axis, is increased by at least 25% compared to a value without inclination or elevation.

2. The static mixing element according to claim 1, wherein the raised edges form a common, straight web on the inlet side in the first axial section, which forms an angle β>100° and β≤120° with the separating web.

3. The static mixing element according to claim 1, wherein the deflection surfaces are planar surfaces inclined against the flow direction by an angle α>15° to the cross-sectional plane and mutually towards the separating web.

4. The static mixing element according to claim 1, wherein the height of the separating web is 0.2-0.35 D and a total height of the mixing element is 0.4-0.7 D.

5. A static mixer in a flow channel comprising at least two static mixing elements according to claim 1, successive static mixing elements of the two static mixing elements arranged one behind the other in the flow direction , the successive static mixing elements are mirror images of each other and respective windows and deflection surfaces of the successive static mixing elements cover each other.

6. A static mixer in a flow channel comprising at least two static mixing elements according to claim 1, successive static mixing elements of the two static mixing elements arranged one behind the other in the flow direction, the successive static mixing elements are mirror images of each other and respective windows and deflection surfaces cover each other, the successive static mixing elements connected to each other by axial connecting elements adapted to a circular tube to form a mixer rod such that the an entirety of the static mixer is capable of being manufactured using an open/close tool.

7. A static mixer in a flow channel comprising: a plurality of static mixing elements according to claim 1, successive static mixing elements of the plurality of static mixing elements arranged one behind the other in the flow direction each individual mixing element in the plurality of static mixing elements connected to an outer ring for reinforcement or form a monolithic part.

8. The static mixing element according to claim 1, wherein the deflection surface is at least partially wedge-shaped or thickened by large radii in a transition area to a tube wall, ring, separating webs, edges, or connecting elements.

9. A method comprising:
providing the static mixing element according to claim 1; and
processing plastic melts through the tube, the tube being circular and serving as a flow channel during the processing of plastic melts.

10. A method comprising:
operating the static mixing element according to claim 1 as a one-way mixer in tube, the tube being circular and serving as a flow channel during the processing of curing resins.

11. A static-dynamic mixer according to claim 6, wherein the mixer rod is connected to a drive configured to set the mixer rod in rotation.

12. The static mixer according to claim 7, wherein the deflection surface is at least partially wedge-shaped or thickened by large radii in a transition area to a tube wall, ring, separating webs, edges, or connecting elements.

13. A method comprising:
providing the static mixer according to claim 7; and
processing plastic melts through the tube, the tube being circular and serving as a flow channel during the processing of plastic melts.

14. A method comprising:
operating the static mixer element according to claim 7 as a one-way mixer in the tube, the tube being circular and serving as a flow channel during the processing of curing resins.
